(19) United States
(12) Patent Application Publication
(10) Pub. No.: US 2011/0249046 A1
(43) Pub. Date: Oct. 13, 2011

(54) LIQUID CRYSTAL DISPLAY DEVICE

(75) Inventors: Seung-Kyu Lee, Yongin-city (KR); Dong-Hoon Lee, Yongin-city (KR); Chul-Ho Kim, Yongin-city (KR)

(73) Assignee: Samsung Mobile Display Co., Ltd., Yongin-city (KR)

(21) Appl. No.: 13/010,372

(22) Filed: Jan. 20, 2011

(30) Foreign Application Priority Data
Apr. 7, 2010 (KR) 10-2010-0031876

(51) Int. Cl. G09G 3/36; G09G 5/02; G09G 5/00

(52) U.S. Cl. 345/691; 345/209; 345/690; 345/88

(57) ABSTRACT

A liquid crystal display (LCD) device is disclosed. In the device an R or B pixel is driven and then a G or W pixel is driven, so that the polarity of the pixels is inversed every two data lines. Thus, problems, such as flicker and a non-uniform picture quality are reduced.

### CROSS-REFERENCE TO RELATED APPLICATIONS

This application claims the benefit of Korean Patent Application No. 10-2010-0031876, filed on Apr. 7, 2010, in the Korean Intellectual Property Office, the disclosure of which is incorporated herein in its entirety by reference.

### BACKGROUND

1. Field

The disclosed technology relates to a liquid crystal display (LCD) device, and more particularly, to an LCD device that can remove flicker and vertical lines.

2. Description of the Related Technology

Liquid Crystal Display (LCD) devices are widely used as display devices for laptop computers and portable televisions because of their light weight, thinness, and low power consumption.

LCD displays have a gate driver and an active level shifter (ALS) driver. The LCD display controls the amount of transmitted light according to a signal applied from the gate driver and the ALS driver to a plurality of control switches that are arranged in a matrix array, so as to display a desired image.

As resolution of an LCD device is increased, an aperture ratio of an LCD panel is decreased, thereby reducing the brightness of the LCD panel. In order to solve this problem, a PenTile type pixel has been proposed. In the PenTile type pixel, a blue unit pixel is shared when displaying two dots. The adjacent blue unit pixel receives a data signal by one data driving circuit, and is driven by different gate driving circuits. In addition, in order to further improve the brightness of the LCD panel, an RGBW type pixel, in which a white (W) pixel is added to R (red), G (green), and B (blue) pixels, has been proposed.

In the PenTile type pixel, unlike a conventional stripe RGB pixel, a pixel patch is arranged in a 2×2 unit matrix, and thus a general timing generator (TG) sequence has problems such as vertical lines and low picture quality. In particular, the PenTile type pixel has a serious problem because the inversion of the 2×2 pixel unit causes solid-color flicker during conventional column inversion driving. In addition, the PenTile type pixel cannot completely solve the vertical line problem caused by a difference of a lateral field occurring between adjacent pixels having different polarities during a 2×2 inversion.

### SUMMARY OF CERTAIN INVENTIVE ASPECTS

One inventive aspect is a liquid crystal display (LCD) device including a liquid crystal panel. The liquid crystal panel includes a plurality of pixels, each pixel connected to one of a plurality of data lines and to one of a plurality of gate lines, where each data line is connected to a column of pixels and each gate line is connected to a row of pixels. The display device also includes a data driver configured to apply data signals to a plurality of output lines, a switching unit configured to sequentially connect each of the output lines to multiple data lines, where the data driver and the switching unit are collectively configured to apply data signals of a first polarity to a first group of adjacent data lines and to apply data signals of a second polarity to a second group of adjacent data lines, and where the second polarity is opposite the first polarity. The display device also includes a gate driver connected to the plurality of gate lines and configured to sequentially apply gate signals to the gate lines.

Another inventive aspect is a liquid crystal display (LCD) device including a liquid crystal panel. The liquid crystal panel includes a plurality of pixels, each pixel connected to one of a plurality of data lines and to one of a plurality of gate lines, where each data line is connected to a column of pixels and each gate line is connected to a row of pixels. The display device also includes a data driver configured to apply data signals to a plurality of output lines, a switching unit configured to sequentially connected each of the output lines to multiple data lines, where the data driver and the switching unit are collectively configured to apply data signals of a first polarity to a first group of adjacent data lines and to apply data signals of a second polarity to a second group of adjacent data lines according to a plurality of control signals, and where the second polarity is opposite the first polarity. The display device also includes a timing controller configured to output the control signals.

### BRIEF DESCRIPTION OF THE DRAWINGS

The above and other features and advantages are described in the context of exemplary embodiments with reference to the attached drawings in which:

FIG. 1 is a schematic diagram illustrating a liquid crystal display (LCD) device according to an embodiment;

FIG. 2 is an equivalent circuit diagram of a pixel of FIG. 1, according to an embodiment;

FIG. 3 is a view illustrating arrangement of pixels in an LCD device, according to an embodiment;

FIG. 4 is a schematic circuit diagram illustrating an internal structure of a switching unit, according to an embodiment;

FIGS. 5 and 6 are waveform diagrams illustrating waveforms of switching control signals applied to a switching unit, according to an embodiment; and

FIG. 7 is a display view illustrating driving voltages applied to pixels of an LCD panel during a column inversion driving, according to an embodiment.

### DETAILED DESCRIPTION OF CERTAIN INVENTIVE EMBODIMENTS

Hereinafter, exemplary embodiments are described in detail with reference to the accompanying drawings. Like reference numerals generally designate like elements throughout the specification. In the description, the detailed descriptions of well-known functions and structures may be omitted so as not to hinder the understanding of the features and embodiments.

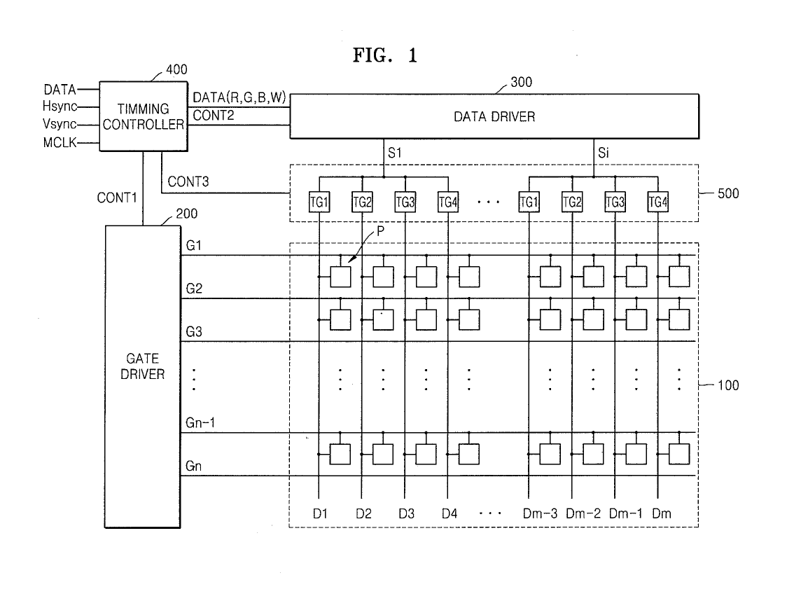

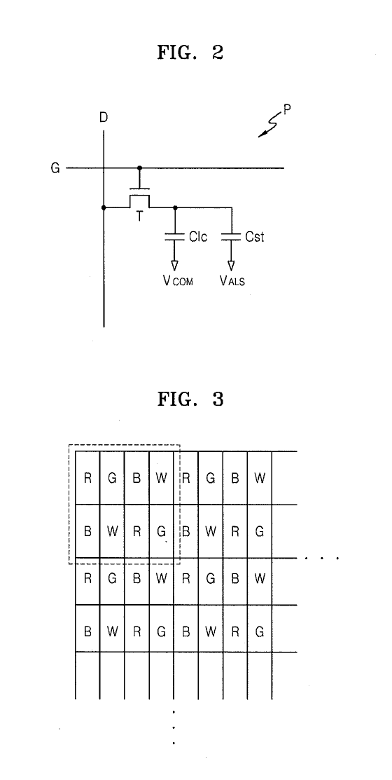

FIG. 1 is a schematic diagram illustrating a liquid crystal display (LCD) device, according to an embodiment. FIG. 2 is a circuit diagram of a pixel of FIG. 1, according to an embodiment.

Referring to FIG. 1, the LCD device includes a liquid crystal panel 100, a gate driver 200, a data driver 300, a timing controller 400, and a switching unit 500.

The liquid crystal panel 100 includes a liquid crystal layer that is formed between first and second substrates. The first substrate of the liquid crystal panel 100 includes data lines D1 through Dm, gate lines G1 through Gn, thin film transistors (TFTs) T, pixel electrodes, liquid crystal capacitors Clc and storage capacitors Cst. The second substrate includes black matrixes BM, color filters, and common electrodes.

The gate driver 200 may generate gate signals including a gate-on voltage of an active level and a gate-off voltage of an inactive level and may sequentially send the gate signals to the liquid crystal panel 100 via the gate lines G1 through Gn. The TFT T may be turned on or turned off by the gate-on or gate-off voltage. The gate lines G1 through Gn extend across the data lines D1 through Dm. The gate voltage is applied to a pixels electrically connected to the data lines D1 through Dm.

The data driver 300 may sequentially send data signals to the liquid crystal panel 100 via the data lines D1 through Dm. The data driver 300 may convert input image data having a grade scale information, which is input from the timing controller 400, into a data signal having a voltage or current form.

The timing controller 400 receives input image data DATA and an input control signal, for controlling display of the input image data DATA, from an external graphic controller (not shown). The input control signal may include, for example, a horizontal synchronous signal Hsync, a vertical synchronous signal Vsync and a main clock signal MCLK. The timing controller 400 sends the input image data DATA (R, G, B, W) to the data driver 300. In addition, the timing controller 400 generates gate control signals CONT1, data control signals CONT2, and switching control signals CONT3 and sends them to the gate driver 200, the data driver 300, and the switching unit 500, respectively.

The switching unit 500 is disposed between the data driver 300 and the liquid crystal panel 100, and connects data signal output lines S1 through Si and the data lines D1 through Dm of the data driver 300. The switching unit 500 includes a plurality of blocks, each of which includes four data lines of the data lines D1 through Dm. The switching unit 500 drives the timing generators TG1 through TG4 connected to the data lines of each block according to the switching control signals CONT3. Each of the timing generators TG1 through TG4 may include a switching device such as a transistor.

The gate lines G1 through Gn are arranged at uniform intervals in a row direction, and the data lines D1 through Dm are arranged at uniform intervals in a column direction. The gate lines G1 through Gn and the data lines D1 through Dm are arranged in a matrix array, and each pixel P is formed in a near intersections of the gate lines G1 through Gn and the data lines D1 through Dm. The pixel P is a minimum unit for forming a display and is switched on or off by the gate voltage, and transmittance of the pixel P is determined by the data signal.

Referring to FIG. 2, the pixel P includes a TFT T, a liquid crystal capacitor Clc and a storage capacitor Cst.

In the TFT T, a gate electrode is connected to the gate line G, a first electrode is connected to the data line D, and a second electrode is connected to a pixel electrode. When a gate-on voltage is applied to the gate electrode, the TFT T is turned on and thus transmits the data voltage from the data line D to the pixel electrode.

The liquid crystal capacitor Clc is connected to the TFT T and maintains an electric field in a liquid crystal layer between the pixel electrode and a common electrode. The liquid crystal capacitor Clc selectively controls the light transmission of the pixel P by changing the arrangement of liquid crystal molecules in the liquid crystal layer according to a data voltage applied to the pixel electrode and the common voltage Vcom.

The storage capacitor Cst includes a pixel electrode and a an active level shift (ALS) line formed to be substantially parallel to the gate line G. An ALS voltage V_{ALS} is applied to the storage capacitor Cst via the ALS line. The storage capacitor Cst maintains a data signal that is charged in the liquid crystal capacitor Clc until the next data signal is charged.

FIG. 3 is a symbolic view illustrating an arrangement of pixels in an LCD device, according to an embodiment.

Referring to FIG. 3, in a PenTile type pixel according to an embodiment, R (red), G (greed), B (blue), and W (white) pixels are arranged in a matrix array. For example, the R, G, B, and W pixels are sequentially arranged in odd rows, and the B, W, R, and G pixels are sequentially arranged in even rows.

Accordingly, the R and B pixels are arranged in the odd columns, and the G and W pixels are arranged in the even columns. However, various arrangements of the pixels are possible, and thus the R, G, B, and W pixels may be arranged so that the pixels of the same color are not successively arranged in row and column directions.

In this manner, the R, G, B, and W pixels may be sequentially connected to odd-numbered gate lines, and the B, W, R, and G pixels may be sequentially connected to even-numbered gate lines.

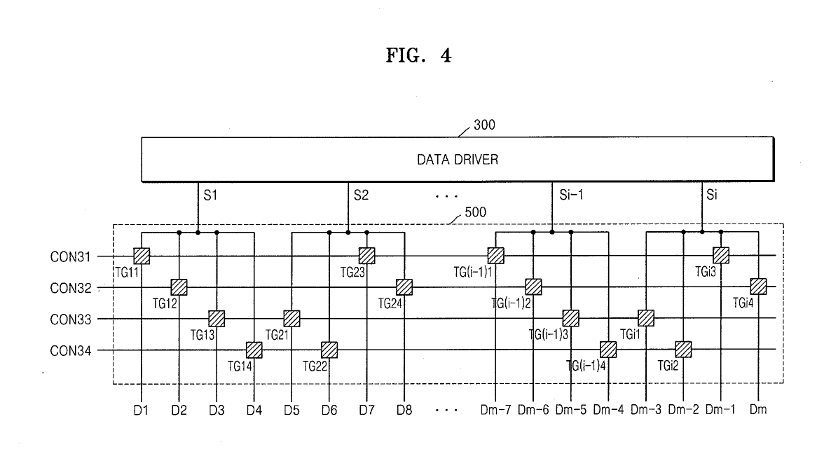

FIG. 4 is a schematic diagram illustrating an internal structure of the switching unit 500 according to an embodiment.

Referring to FIG. 4, the switching unit 500 connects the data signal output lines S1 through Si of the data driver 300 and the data lines D1 through Dm of the liquid crystal panel 100.

The switching unit 500 includes a plurality of blocks, each of which includes four data lines that are connected to one of four columns of pixels. A data signal applied to each of the data signal output lines S1 through Si is transmitted to the four data lines for an interval of time. Each block includes four timing generators TG1 through TG4 that operate according to four switching control signals CON31 through CON34. Each data line includes one timing generator TG, and each timing generator TG is turned on according to the switching control signal CON3x so as to transmit the data signal applied to the data signal output lines S1 through Si to the data lines D1 through Dm. The timing generators TG1 through TG4 may include a transistor as a switching device.

In blocks for odd-numbered signal output lines S1 through Si, first timing generators TG11 through TG i−1 1 are driven according to the first switching control signal CON31, second timing generators TG12 through TG i−1 2 are driven according to the second switching control signal CON32, third timing generators TG13 through TG i−1 3 are driven according to the third switching control signal CON33, and fourth timing generators TG14 through TG i−1 4 are driven according to the fourth switching control signal CON34.

In blocks for even-numbered signal output lines S1 through Si, first timing generators TG21 through TGi1 are driven according to the third switching control signal CON33, second timing generators TG22 through TGi2 are driven according to the fourth switching control signal CON34, third timing generators TG23 through TGi3 are driven according to the first switching control signal CON31, and fourth timing generators TG24 through TGi4 are driven according to the second switching control signal CON32.

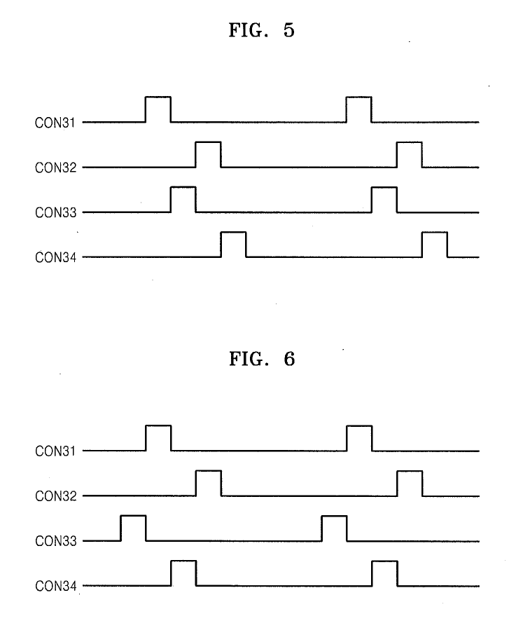

FIGS. 5 and 6 are waveform diagrams illustrating waveforms of switching control signals applied to a switching unit, according to an embodiment. FIG. 5 is a waveform diagram of switching control signals for odd-numbered gate lines, and FIG. 6 is a waveform diagram of switching control signals for even-numbered gate lines.

Referring to FIG. 5, in the case of an odd-numbered gate line, the first switching control signal CON31, the third switching control signal CON33, the second switching control signal CON32, and the fourth switching control signal CON34 of active levels may be sequentially applied to the switching unit.

Accordingly, in the blocks of odd-numbered signal output lines, the first timing generators TG11 through TG i−1 1, the third timing generators TG13 through TG i−1 3, the second timing generators TG12 through TG i−1 2, and the fourth timing generators TG14 through TG i−1 4 may be sequentially turned on. In the blocks of even-numbered signal output lines, the third timing generators TG23 through TGi3, the first timing generators TG21 through TGi1, the fourth timing generators TG24 through TGi4, and the second timing generators TG22 through TGi2 may be sequentially turned on.

For example, the R, G, B, and W pixels may be sequentially arranged along a first gate line G1, and if a gate-on signal is applied to the first gate line G1, TFTs connected to the first gate line G1 are turned on.

When data signals are applied via a first output line S1, the first timing generator TG11, the third timing generator TG13, the second timing generator TG12, and the fourth timing generator TG14 are sequentially turned on. The data signals applied to the first timing generator TG11, the third timing generator TG13, the second timing generator TG12, and the fourth timing generator TG14 are sequentially applied to corresponding data lines, that is, to D1, D3, D2, and D4. Accordingly, the data signals are sequentially applied to the R, B, G, and W pixels.

When data signals are applied via a second output line S2, the third timing generator TG23, the first timing generator TG21, the fourth timing generator TG24, and the second timing generator TG22 are sequentially turned on. The data signals sequentially applied to the third timing generator TG23, the first timing generator TG21, the fourth timing generator TG24, and the second timing generator TG22 are sequentially applied to corresponding data lines, that is, to D7, D5, D8 and D6. Accordingly, the data signals are sequentially applied to the B, R, W, and G pixels.

Referring to FIG. 6, in the case of an even-numbered gate line, the third switching control signal CON33, the first switching control signal CON31, the fourth switching control signal CON34, and the second switching control signal CON32 of active levels are sequentially applied to the switching unit.

Accordingly, in the blocks of odd-numbered signal output lines, the third timing generators TG13 through TG i−1 3, the first timing generators TG11 through TG i−1 1, the fourth timing generators TG14 through TG i−1 4, and the second timing generators TG12 through TG i−1 2 are sequentially turned on. In the blocks of even-numbered signal output lines, the first timing generators TG21 through TGi1, the third timing generators TG23 through TGi3, the second timing generators TG22 through TGi2, and the fourth timing generators TG24 through TGi4 are sequentially turned on.

For example, the B, W, R, and G pixels may be sequentially arranged in a second gate line G2, and if a gate-on signal is applied to the second gate line G2, TFTs connected to a second gate line G2 are turned on.

When data signals are applied via the first output line S1, the third timing generator TG13, the first timing generator TG11, the fourth timing generator TG14, and the second timing generator TG12 are sequentially turned on. The data signals sequentially applied to the third timing generator TG13, the first timing generator TG11, the fourth timing generator TG14, and the second timing generator TG12 are applied to corresponding data lines, that is, to the D3, D1, D4, and D2. Accordingly, the data signals are sequentially applied to the R, B, G and W pixels.

When data signals are applied via the first output line S2, the first timing generator TG21, the third timing generator TG23, the second timing generator TG22, and the fourth timing generator TG24 are sequentially turned on. The data signals sequentially applied to the first timing generator TG21, the third timing generator TG23, the second timing generator TG22, and the fourth timing generator TG24 are applied to corresponding data lines, that is, to the D5, D7, D6, and D8. Accordingly, the data signals are sequentially applied to the B, R, W and G pixels.

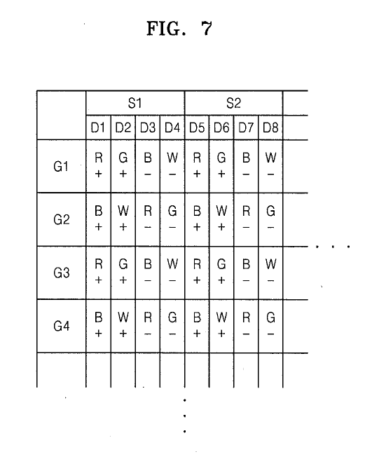

FIG. 7 is a symbolic view illustrating driving voltage polarities applied to a pixel of an LCD panel during a column inversion driving method according to an embodiment.

Referring to FIG. 7, R, G, B and W pixels are sequentially arranged in an odd-numbered gate line. Data signals with positive, negative, positive, and negative polarities are sequentially applied from each of odd-numbered output lines S1 through Si−1. Data signals with negative, positive, negative, and positive polarities are sequentially applied from each of even-numbered output lines S2 through Si.

Referring FIGS. 5 and 7, in the case of an odd-numbered gate line, the first switching control signal CON31, the third switching control signal CON33, the second switching control signal CON32, and the fourth switching control signal CON34 of active levels are sequentially applied to the switching unit.

In blocks of odd-numbered signal output lines, the first timing generators TG11 through TG i−1 1, the third timing generators TG13 through TG i−1 3, the second timing generators TG12 through TG i−1 2, and the fourth timing generators TG14 through TG i−1 4 are sequentially turned on. Accordingly, data signals with positive, negative, positive, and negative polarities are sequentially applied to the R, B, G, and W pixels, respectively, and thus the R, G, B, and W pixels have positive, positive, negative, and negative polarities, respectively.

In blocks of even-numbered signal output lines, the third timing generators TG23 through TGi3, the first timing generators TG21 through TGi1, the fourth timing generators TG24 through TGi4, and the second timing generators TG22 through TGi2 are sequentially turned on. Accordingly, data signals with negative, positive, negative, and positive polarities are sequentially applied to the B, R, W, and G pixels, respectively, and thus the R, G, B, and W pixels have positive, positive, negative, and negative polarities, respectively.

When a gate-on signal is applied to a first gate line G1, TFTs connected to the first gate line G1 are turned on.

When data signals with positive, negative, positive, and negative polarities are applied via a first output line S1, the first timing generator TG11, the third timing generator TG13, the second timing generator TG12, and the fourth timing generator TG14 are sequentially turned on. Accordingly, data signals with positive, negative, positive, and negative polarities are sequentially applied to the R, B, G, and W pixels, respectively, and thus the R, G, B, and W pixels have positive, positive, negative, and negative polarities, respectively.

When data signals with negative, positive, negative, and positive polarities are applied via a second output line S2, the third timing generator TG23, the first timing generator TG21, the fourth timing generator TG24, and the second timing generator TG22 are sequentially turned on. Accordingly, data signals with negative, positive, negative, and positive polarities are sequentially applied to the B, R, W, and G pixels, respectively, and thus the R, G, B, and W pixels have positive, positive, negative, and negative polarities, respectively.

Referring again to FIG. 7, the B, W, R, and G pixels are sequentially arranged in the even-numbered gate line. The data signals with negative, positive, negative, and positive polarities are sequentially applied from the odd-numbered output lines S1 through Si−1, and the data signals with positive, negative, positive, and negative polarities are sequentially applied from the even-numbered output lines S2 through Si.

Referring to FIGS. 6 and 7, in the case of the even-numbered gate line, the third switching control signal CON33, the first switching control signal CON31, the fourth switching control signal CON34, and the second switching control signal CON32 are sequentially applied to the switching unit.

In the blocks of odd-numbered signal output lines, the third timing generators TG13 through TG i−1 3, the first timing generators TG11 through TG i−1 1, the fourth timing generators TG14 through TG i−1 4, and the second timing generators TG12 through TG i−1 2 are sequentially turned on. Accordingly, the data signal with negative, positive, negative, and positive polarities are sequentially applied to the R, B, G, and W pixels, respectively, and thus the B, W, R, and G pixels have positive, positive, negative, and negative polarities, respectively.

In the blocks of even-numbered signal output lines, the first timing generators TG21 through TGi1, the third timing generators TG23 through TGi3, the second timing generators TG22 through TGi2, and the fourth timing generators TG24 through TGi4 are sequentially turned on. Accordingly, the data signals with positive, negative, positive, and negative polarities are applied to the B, R, W, and G pixels, respectively, and thus the B, W, R, and G pixels have positive, positive, negative, and negative polarities, respectively.

When a gate-on signal is applied to a second gate line G2, TFTs connected to the second gate line G2 are turned on.

When the data signals with negative, positive, negative, and positive polarities are applied via a first output line S1, the third timing generator TG13, the first timing generator TG11, the fourth timing generator TG14, and the second timing generator TG12 are sequentially turned on. Accordingly, the data signals with negative, positive, negative, and positive polarities are sequentially applied to the R, B, G, and W pixels, respectively, and thus the B, W, R, and G pixels have positive, positive, negative, and negative polarities, respectively.

When the data signals with positive, negative, positive, and negative polarities are applied via a second output line S2, the first timing generator TG21, the third timing generator TG23, the second timing generator TG22, and the fourth timing generator TG24 are sequentially turned on. Accordingly, the data signals with positive, negative, positive, and negative polarities are sequentially applied to the B, R, W, and G pixels, respectively, and thus the B, W, R, and G pixels have positive, positive, negative, and negative polarities, respectively.

According to the discussed embodiments, a data signal is applied to a R or B pixel and then is applied to a G or W pixel, so that all pixel rows have the same polarity, and the polarity is inversed for every two pixel columns. Thus, the adjacent pixels are not affected, thereby preventing vertical lines and flickers from being generated.

Also, in a PenTile type pixel, an inversion driving method is performed in every two lines so that all pixels have the same lateral field, thereby decreasing power consumption for a 2×2 pixel inversion by about 30%.

According to some embodiments, an inversion driving method is performed in every two data lines, a driving order is selectively controlled by using four timing generators, and thus problems, such as flicker and a non-uniform picture quality that is different at left and right sides of the screen, can be solved, thereby reducing power consumption.

While various aspects have been particularly shown and described with reference to exemplary embodiments, it will be understood by those of ordinary skill in the art that various changes in form and details may be made therein.

What is claimed is:

1. A liquid crystal display (LCD) device comprising:
a liquid crystal panel comprising a plurality of pixels, each pixel connected to one of a plurality of data lines and to one of a plurality of gate lines, wherein each data line is connected to a column of pixels and each gate line is connected to a row of pixels;
a data driver configured to apply data signals to a plurality of output lines;
a switching unit configured to sequentially connect each of the output lines to multiple data lines, wherein the data driver and the switching unit are collectively configured to apply data signals of a first polarity to a first group of adjacent data lines and to apply data signals of a second polarity to a second group of adjacent data lines, and wherein the second polarity is opposite the first polarity; and
a gate driver connected to the plurality of gate lines and configured to sequentially apply gate signals to the gate lines.

2. The LCD device of claim 1, wherein the liquid crystal panel comprises:
a first pixel row comprising a first pixel for displaying a first color, a second pixel for displaying a second color, a third pixel for displaying a third color, and a fourth pixel for displaying a fourth color that are sequentially arranged; and
a second pixel row comprising a fifth pixel for displaying the third color, a sixth pixel for displaying the fourth color, a seventh pixel for displaying the first color, and an eighth pixel for displaying the second color that are sequentially arranged,
wherein the first pixel and the fifth pixel are in the same column.

3. The LCD device of claim 1, wherein the data driver applies data signals having opposite polarities to an odd-numbered output line and an even-numbered output line.

4. The LCD device of claim 2, wherein the switching unit sequentially applies the data signals of the odd-numbered output line to the data lines connected to the first pixel, the third pixel, the second pixel, and the fourth pixel.

5. The LCD device of claim 2, wherein the switching unit sequentially applies the data signals of the even-numbered output line to the data lines connected to the third pixel, the first pixel, the fourth pixel, and the second pixel.

6. The LCD device of claim 1, wherein the switching unit connects one output line and four data lines that are sequentially arranged and comprises first, second, third, and fourth timing generators configured to selectively apply the data signals to the four data lines according to control signals.

7. The LCD device of claim 6, wherein if a gate-on voltage is applied to an odd-numbered gate line, the data signals of the odd-numbered output line are sequentially applied via one of the first timing generators to a first pixel, one of the third timing generators to a third pixel, one of the second timing generators to a second pixel, and one of the fourth timing generators to a fourth pixel; and the data signals of the even-numbered output line are sequentially applied via one of the third timing generators to a seventh pixel, one of the first timing generators to a fifth pixel, one of the fourth timing generators to an eighth pixel, and one of the second timing generators to a sixth pixel, wherein the first, second, third, fourth, fifth, sixth, seventh, and eighth pixels are sequentially arranged in the row of the odd-numbered gate line.

8. The LCD device of claim 6, wherein if a gate-on voltage is applied to an even-numbered gate line, the data signals of the odd-numbered output line are sequentially applied via one of the third timing generators to a third pixel, one of the first timing generator to a first pixel, one of the fourth timing generator to a fourth pixel, and one of the second timing generators to a second pixel; and the data signals of the even-numbered output line are sequentially applied via one of the first timing generator to a fifth pixel, one of the third timing generator to a seventh pixel, one of the second timing generator to a sixth pixel, and one of the fourth timing generator to an eighth pixel, wherein the first, second, third, fourth, fifth, sixth, seventh, and eighth pixels are sequentially arranged in the row of the even-numbered gate line.

9. The LCD device of claim 6, further comprising a timing controller for outputting the control signals.

10. The LCD device of claim 2, wherein the first, second, third, and fourth colors are red, green, blue, and white, respectively.

11. A liquid crystal display (LCD) device comprising:
a liquid crystal panel comprising a plurality of pixels, each pixel connected to one of a plurality of data lines and to one of a plurality of gate lines, wherein each data line is connected to a column of pixels and each gate line is connected to a row of pixels;
a data driver configured to apply data signals to a plurality of output lines;
a switching unit configured to sequentially connect each of the output lines to multiple data lines, wherein the data driver and the switching unit are collectively configured to apply data signals of a first polarity to a first group of adjacent data lines and to apply data signals of a second polarity to a second group of adjacent data lines according to a plurality of control signals, and wherein the second polarity is opposite the first polarity; and
a timing controller configured to output the control signals.

12. The LCD device of claim 11, wherein the switching unit connects one output line and four data lines that are sequentially arranged, and comprises first, second, third, and fourth timing generators configured to selectively apply the data signals to the four data lines according to the plurality of control signals.

13. The LCD device of claim 12, wherein the timing controller is configured to generate:
a first control signal for turning on the first timing generator connected to an odd-numbered output line and the third timing generator connected to an even-numbered output line;
a second control signal for turning on the second timing generator connected to the odd-numbered output line and the fourth timing generator connected to the even-numbered output line;
a third control signal for turning on the third timing generator connected to the odd-numbered output line and the first timing generator connected to the even-numbered output line; and
a fourth control signal for turning on the fourth timing generator connected to the odd-numbered output line and the second timing generator connected to the even-numbered output line.

14. The LCD device of claim 13, wherein if a gate-on voltage is applied to an odd-numbered gate line, the timing controller sequentially outputs the first control signal, the third control signal, the second control signal, and the fourth control signal.

15. The LCD device of claim 13, wherein if the gate-on voltage is applied to an even-numbered gate line, the timing controller sequentially outputs the third control signal, the first control signal, the fourth control signal, and the second control signal.

16. The LCD device of claim 11, wherein the liquid crystal panel comprises:
a first pixel row comprising a first pixel for displaying a first color, a second pixel for displaying a second color, a third pixel for displaying a third color, and a fourth pixel for displaying a fourth color that are sequentially arranged; and
a second pixel row comprising a fifth pixel for displaying the third color, a sixth pixel for displaying the fourth color, a seventh pixel for displaying the first color, and an eighth pixel for displaying the second color that are sequentially arranged,
wherein the first pixel and the fifth pixel are in the same column.

17. The LCD device of claim 11, wherein the data driver applies data signals having opposite polarities to the odd-numbered output line and the even-numbered output line.

18. The LCD device of claim 16, wherein the first, second, third, and fourth colors are red, green, blue, and white, respectively.

19. The LCD device of claim 16, wherein the second pixel and the sixth pixel are in the same column, the third pixel and the seventh pixel are in the same column, and the fourth pixel and the eighth pixel are in the same column.

20. The LCD device of claim 11, wherein the data driver is configured to drive the liquid crystal panel with a column inversion driving method.
